(19) United States
(12) Patent Application Publication
(10) Pub. No.: US 2010/0125386 A1
(43) Pub. Date: May 20, 2010

(54) FALSE ALARM MANAGEMENT IN DAS AND CSW SYSTEM USING FALSE ALARM DATABASE AND MAP DATABASE SENSOR

(76) Inventor: Faroog Abdel-kareem Ibrahim, Dearborn Heights, MI (US)

Correspondence Address: FRASER CLEMENS MARTIN & MILLER LLC, 28366 KENSINGTON LANE, PERRYSBURG, OH, 43551, US

(21) Appl. No.: 12/261,667

(22) Filed: Oct. 30, 2008

(51) Int. Cl. G06F 7/00; G06F 17/30

(52) U.S. Cl. 701/36

(57) ABSTRACT

A management system for a vehicle including a database adapted to store a plurality of records, wherein each of the records represents an output of a vehicle system and a processor in communication with the database and the vehicle system, wherein the processor receives the output of the vehicle system, analyzes the output, manages the records in the database in response to the analysis of the output, and controls the transmission of the output to a driver of the vehicle in response to at least one of the analysis of the output of the vehicle system and the records in the database.

### FIELD OF THE INVENTION

The invention relates to vehicle systems. More particularly, the invention is directed to a management system and method for managing false activations in a vehicle system.

### BACKGROUND OF THE INVENTION

Customer acceptance of warning and control systems decreases as the number of false activation (warning or control action) increases. A high rate of false and nuisance activations may push the driver to turn the system off or just ignore the system warning as a result of lack of trust in the system performance. Current technologies reduce the false activation by limiting the system performance. Even with the performance limitations tradeoff, false activation rate remains high in existing commercial Driver Awareness Systems (DAS).

Many of the false activations in vehicle systems are “location specific”. For example, in forward collision warning (FCW) systems, overpasses, traffic lights, telephone lines, road signs, sewerage coverage, and special road geometry are the main causes of a false alarm. Similar causes can lead to undesired brake or throttle activations in adaptive cruise control (ACC) systems. Lines on pavement other than a lane marking, a special lane marking geometry, a shadow effect, and a special road structure can lead to false warning of a lane departure warning (LDW) system or undesired steering activation for lane keeping systems. In a curve speed warning (CSW) system, map database errors and map matching errors are the main causes for CSW false warning. The CSW errors can also apply on a map based/navigation based Predictive Adaptive Front Lighting (PAFS), where the headlamps are swiveled based on the upcoming road curvature calculated from the map database. Additionally, the cooperation of multiple systems extends the errors from false warnings to false control activation of associated control systems. For example, where the ACC is combined with the CSW to reduce speed on curves, or where the FCW warning is followed by collision countermeasure system (CMS) activation.

It would be desirable to provide a management system for a vehicle system and a method for managing false activations in the vehicle system, wherein the management system and method maximize the accuracy of an activation output generated and transmitted by the vehicle system, thereby maximizing a driver's confidence in the vehicle system and the associated activation outputs, while minimizing accidents due to false activation outputs.

### SUMMARY OF THE INVENTION

Concordant and consistent with the present invention, a management system for a vehicle system and a method for managing false activations in the vehicle system, wherein the management system and method maximize the accuracy of an activation output generated and transmitted by the vehicle system, thereby maximizing a driver's confidence in the vehicle system and the associated activation outputs, while minimizing accidents due to false activation outputs, has surprisingly been discovered.

In one embodiment, a management system comprises: a vehicle system that generates and transmits an output; and an activation classification component in communication with the vehicle system, wherein the activation classification component receives the output of the vehicle system, analyzes the output of the vehicle system, and controls the vehicle system in response to the output analysis.

In another embodiment, a management system comprises: a vehicle system that generates and transmits an output; a database adapted to store a plurality of records, wherein each of the records represents a road fragment associated with the output of the vehicle system; and an activation classification component in communication with the database and the vehicle system, wherein the activation classification component receives the output of the vehicle system, analyzes the output of the vehicle system, manages the records in the database in response to the analysis of the output, and controls the vehicle system in response to at least one of the output analysis and the records in the database.

The invention also provides methods for managing false activation outputs in a vehicle system.

One method comprises the steps of: analyzing an output of the vehicle system; storing a plurality of records, wherein each record represents a road fragment associated with the output of the vehicle system; managing the records in response to the analysis of the output of the vehicle system; and controlling the output of the vehicle system in response to at least one of the output analysis and the stored records.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic diagram of a management system according to an embodiment of the present invention; and

FIG. 2 is a schematic diagram of a false alarm database according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

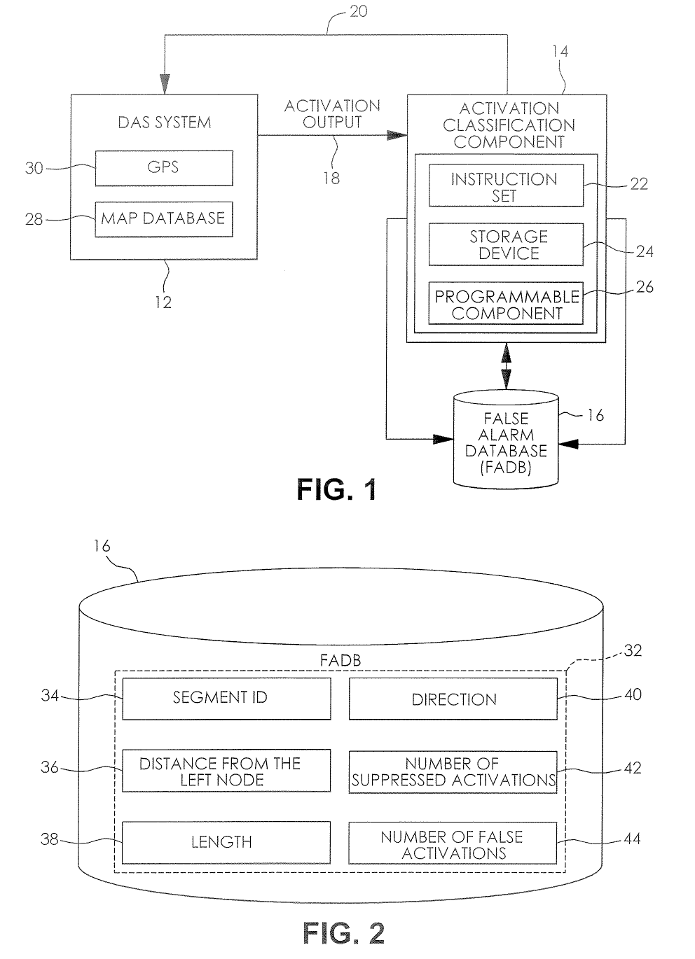

FIG. 1 illustrates a false alarm management system 10 according to the present invention. The management system 10 includes a driver awareness and assistance system (DAS) 12, an activation classification component 14, and a False Alarm Database (FADB) 16. However, it is understood that the management system 10 may include additional components, systems and devices, as desired.

The DAS 12 may be any system or device adapted to provide an activation output 18. In certain embodiments, the activation output 18 represents a warning to a driver of a vehicle, wherein the warning relates to road conditions, vehicle conditions, vehicle position, or vehicle environment, for example. It is understood that the activation output 18 may represent other warnings, alerts, and information, as desired. As a non-limiting example, the DAS 12 may be system similar to the systems described in applicant's commonly owned U.S. Pat. Appl. Pub. Nos. 2007/0052555, 2005/0251335, 2008/0239734, 2008/0239698, and 2006/0178824, each of which is hereby incorporated herein by reference in its entirety. It is understood that other warning systems, driver awareness systems, and driver alert system may be used, as desired.

The activation classification component 14 is in communication with the DAS 12 and the FADB 16. The activation classification component 14 is adapted to receive the activation output 18 from the DAS 12, analyze the activation output 18, manage the information stored in the FADB 16 in response to the analysis of the activation output 18, and provide a feedback 20 to the DAS 12. It is understood that the feedback 20 may be dependent upon the information stored in the FADB 16 and data and information retrieved from the DAS 12, for example. Specifically, the activation classification component 14 is adapted to analyze the activation output 18 of the DAS 12 to determine whether the activation output 18 is a valid activation or a false activation. It is understood that the activation classification component 14 may have additional functions, as desired.

In certain embodiments, the activation classification component 14 is a micro-processor adapted to analyze the activation output 18 based upon an instruction set 22 or a learning algorithm. The instruction set 22, which may be embodied within any computer readable medium, includes processor executable instructions for configuring the activation classification component 14 to perform a variety of tasks.

The activation classification component 14 may also include a storage device 24. The storage device 24 may be a single storage device or may be multiple storage devices. Furthermore, the storage device 24 may be a solid state storage system, a magnetic storage system, an optical storage system or any other suitable storage system or device. It is understood that the storage device 24 is adapted to store the instruction set 22. Other data and information may be stored in the storage device 24, as desired.

The activation classification component 14 may further include a programmable component 26. In certain embodiments, the programmable component 26 is adapted to manage and control processing functions of the activation classification component 14. Specifically, the programmable component 26 is adapted to control the analysis of the activation output 18 and the transmission of the feedback 20. It is understood that the programmable component 26 may be adapted to manage the information stored in the FADB 16. It is further understood that the programmable component 26 may be adapted to store data and information in the storage device 24 and retrieve data and information from the storage device 24.

In the embodiment shown, the FADB 16 is a Structured Query Language (SQL) database. However, other databases and computer languages may be used, as desired. As shown, the FADB 16 is in communication with the activation classification component 14, wherein the activation classification component 14 is adapted to manage and query the data and information stored in the FADB 16. As a non-limiting example, the implementation of the FADB 16 is based on a map database 28 and a GPS-based location system 30 included in the DAS 12. Where the DAS 12 issues the activation output 18, the current vehicle position calculated by the GPS 30 is map matched to a position in the map database 28 to define the start and end location of a road fragment where the false activation output 18 occurs. For example, a road fragment may be defined as a sub-section of a map defined road segment where the DAS 12 generates the false activation output 18.

Specifically, where the activation output 18 is determined to be false, a road fragment record 32 is created in the FADB 16, wherein the record 32 is associated with a particular map segment where the “false” activation output 18 occurs. It is understood that the cataloging or recording of the false activation output 18 may be based on additional detailed map segment attributes and sub segments, as defined by pre-determined fields and associated rules. It is further understood that the record 32 in the FADB 16 represents a road fragment associated with an untrue (false or may be false) activation output 18 generated by the DAS 12. In certain embodiments, the record 32 includes information fields based upon pre-determined rules. It is understood that any number of fields may be include in the record 32.

Referring to FIG. 2 there is illustrated the FADB 16 including a record 32 having a plurality of information fields 34, 36, 38, 40, 42, 44. As shown, the record 32 includes a Segment ID 34, a Distance from Left Node (DLN) 36, a Length 38, a Direction 40, a Number of Suppressed Activations 42, and a Number of False Activations 44. It is understood that additional fields may be used, as desired. It is further understood that the fields and rules defining the records 32 may be modified, as desired.

The Segment ID 34 is a unique identifier of the map segment based upon the version of the map database 28 and the coded computer language. The DLN field 36 is a distance measurement representing the beginning of the false activation road fragment from the left node of the map segment in which the false activation output 18 was generated. The Length field 38 represents the length of the road fragment, wherein the maximum length of each road fragment is limited to the length of the associated map segment 34. The Direction field 40 represents the direction of travel when the activation output was generated. The Number of Suppressed Activations field 42 represents the number of false activation output iterations that were suppressed on a particular road fragment. The Number of False Activations field 44 represents the number of false activation output iterations that are detected on a particular road fragment. In certain embodiments, each of the created records 32 is associated with only one map segment. Where the false activation output 18 is generated at the junction of two map segments, two fragment records 32 are added to the FADB 16 (one record 32 for each map segment). The records 32 are each indexed by the Segment ID 34, wherein multiple fragment records 32 with the same Segment ID 34 are sorted by a secondary field, such as, the DLN field 36.

In certain embodiments, the FADB 16 includes programmable code to export the records 32 and data into a simple comma delimited file that can be imported into a software package, such as, Microsoft Excel or Relational Database, for example. A text file in the same format may also be imported into the FADB 16. It is understood that other formats may be used, as desired. The import and export features can be used for merging the records 32 from multiple FADB's 16 in various vehicles or for importing and editing the records 32 and data. For example, an initial database may be formed by combining the records 32 from different development vehicles. As such, the initial database may be installed into production vehicles, wherein the records 32 of the initial database reflect the information gained from the development vehicles. The FADB 16 may also be in communication with a map display entity manager component that will show the “false warning” road fragments on a digital map display.

In use, the DAS 12 generates the activation output 18 according to the pre-determined functionality of the DAS 12. In some instances, the DAS 12 generates a false activation output 18. Specifically, the activation classification component 14, in cooperation with components of the DAS 12, receives vehicle information related to position and motion of the vehicle and detects whether each of the activation outputs 18 is true or false. It is understood that other information such as road attributes may be analyzed in determining the true or false status of the activation outputs 18. It is further understood that the analysis performed by the activation classification component 14 may be pre-programmed, as desired. As a non-limiting example, each of the activation outputs 18 is analyzed to determine if a driver response is detected around the time the activation output 18 is generated, wherein the detection of a driver response may indicate a true or valid activation. Where the activation output 18 is a curve speed warning and the diver applies the vehicle brakes around the warning time or soon thereafter, the application of the vehicle brakes indicates that the warning is “valid activation”. In a Lane Departure Warning system (LDW) and Lane Change Merge (LCM), if the driver maneuvers the vehicle at the time of the warning or soon thereafter, then the vehicle steering indicates that the warning is “valid activation”. In an Adaptive Cruise Control (ACC) system, if the driver does not override the braking, then it indicates that the activation output 18 is a valid activation. As a further example, each of the activation outputs 18 is analyzed based on a repeated occurrence at the same location, as defined by the GPS 30 and map-matching, wherein a pre-determine number of repeated activation outputs 18 at the same location may represent a false activation. Other means for and methods of determining the “valid” or “false” status of the activation output 18 may be used, as desired.

Once the activation classification component 14 analyzes the received activation output 18, the activation classification component 14 manages the records 32 of the FADB 16 in response to the analysis of the activation output 18. For example, where the activation output 18 is categorized as untrue (false or may be false), it is stored in the FADB 16 as one of the records 32. Where the activation output 18 is transmitted at a repeat location, as defined by the fields of the record 32, the Number of False Activations 44 for the particular record 32 is incremented. Where the activation output 18 is categorized as a true or valid activation, the Number of False Activations field 44 is decremented or reset to a small number (e.g. zero). It is understood that the analysis and managing functions of the activation classification component 14 may be controlled by a learning algorithm embedded in the instruction set 22. As such, the activation classification component 14 manages the generation and transmission of the false activation outputs 18 in response to the data and information stored in the records 32 of the FADB 16.

Specifically, once the Number of False Activations field 44 for one of the records 32 exceeds a pre-determined threshold, the feedback 20 is transmitted to the DAS 12 and the activation output 18 is suppressed or modified for the repeat location associated with the particular record 32. It is understood that the threshold may be adjusted, as desired. It is further understood that the suppression and modification of the activation outputs 18 generated by the DAS 12 may be controlled by the activation classification component 14 in response to the instruction set 22. As a non-limiting example, the suppression of the activation output 18 prevents the activation output 18 from being transmitted to the driver of the vehicle. However, other modifications may be made to the transmission of the activation output 18, as desired.

In certain embodiments, when the false activation output 18 is detected, the FADB 16 is queried to determine if the activation output record 32 already exists in the FADB 16. If the record 32 does not exist in the FADB 16, the record 32 is added to the FADB 16. If the record 32 already exists in the FADB 16, the record 32 is checked to determine if the activation output 18 associated with the record 32 is suppressed or modified. If the activation output 18 is not suppressed, the Number of False Activations 44 is incremented. If the activation output 18 is suppressed, the Number of Suppressed Activations 42 is incremented. Accordingly, the activation classification component 14 is pre-programmed to transmit the feedback 20 to the DAS 12 to control the generation of the activation outputs 18 and the transmission of the activation outputs 18 to the driver, in response to the information contained in the records 32 stored in the FADB 16. It is understood that additional information and data may be analyzed by the activation classification component 14 for generating the feedback 20.

As a non-limiting example, each of fields of each of the records 32 may be updated to ensure that a single activation output 18 is not treated as multiple warnings for the same map segment in the FADB 16. Specifically, where a new warning is detected on a fragment that already exists in the FADB 16, but the Length 38 of the fragment for the new warning is longer than the recorded fragment in the FADB 16, the fragment Length 38 in the database is increased and a new separate fragment record 32 is not created.

In one embodiment, the management system 10 may be integrated with a curve speed warning system (CSW). As is known to someone skilled in the art of CSW systems, current CSW systems depend on the curvature of the calculated most likely path (MLP). Current commercial map databases relied upon in CSW systems are designed for navigation purposes. The accuracy of the currently implemented maps may be sufficient for navigation. However, the current map databases sometimes fail in situations such as service drive/highway intersections, highway/exit ramp intersections, road branching scenarios, complex overpasses/underpasses, and mountain area/single road scenarios, the result of which could lead to placing the vehicle on the wrong road or off the road.

In conventional improvements, the absolute and relative accuracies of CSW systems have been improved by the continuing replacement of the older map database shape points with a higher quality Advanced Driver Assistance System (ADAS) shape points. However, the accuracy of the ADAS map is still inadequate in many of the branching scenarios and scenarios in which three-dimensional information is required. For path prediction algorithms, a map accuracy level that places a vehicle on the wrong road segment leads to an incorrect set of the road candidates, which produces the wrong MLP. In cases where the correct vehicle position is available, relative accuracy is the determining factor in path prediction. An accurate relative placement of the shape points along the MLP means an accurate curvature distribution along this path. The rules and methods of creating the map database (ADAS or older) can lead to very low relative accuracy in some road scenarios. For example, the “connectivity rule,” requires addition of extra shape points for connectivity purpose, (i.e. to provide continuity between road segments of different roads). The added shape points are not part of the road geometry and can lead to incorrect curvature values along the path. Other rules, such as the “merging rule” in connecting a divided road with an undivided road or vice versa or connecting an on-ramp with a main road, can also lead to a misleading representation of the path geometry.

Accordingly, the management system 10 in cooperation with the CSW system provides additional measures to distinguish between true warning and false warning by comparing the calculated MLP curvature and the traversed curvature after the activation output 18 is generated. Where the calculated MLP curvature matches the traversed curvature, (within an acceptable pre-determined error), the activation output 18 or warning is classified as valid or true warning. Additionally, the activation classification component 14 analyzes the MLP for possible map error and returns a flag showing whether the warning should be suppressed. In certain embodiments, the activation classification component 14 suppresses activation outputs 18 where the map matching confidence flag is set to low. Potential sources of map error include: an error in the map database; an overpass scenario; a road merging scenario; a special intersection scenario; a change in the number of lanes; and multi-digitized road. As such, the activation classification component 14 determines if the MLP contains one or more “false warning” fragment records 32 in the FADB 16 and the Number of False Activations field 44 exceeds a pre-determined threshold value.

The overpass scenario creates extra shape points for connectivity purposes which can lead to a high curvature value. Accordingly, the activation classification component 14, in cooperation with the components of the CSW system, determines if the MLP crosses an overpass. In certain embodiments, the activation output 18 associated with overpass may be suppressed.

The merging road scenario creates a number of wrong shape points at the merging end (i.e. creating a high curvature). Accordingly, the activation classification component 14 may suppresses the activation output 18 where the MLP contains road merging.

The special intersection scenario is similar to the merging problem. The activation classification component 14 may suppress the activation output 18 where the MLP ends or passes an intersection that ends with a curvature.

The number of lanes scenario relates to changes in a single road. As a result of the change, the map representation (center of the road) moves near the transition location and produces wrong road representation. Accordingly, the activation classification component 14 may suppress the activation output 14 at locations where there are a number of lane transitions.

The multi-digitized maps scenario relates to road representation. Specifically, the map generally represents the center of the road. Where the road changes from divided to undivided, the center shifts, and as result the map creates a wrong representation of the road. The road split results in curvature values that are not truly representative of the actual curvature of the road. Accordingly, the activation classification component 14 suppresses activation outputs 18 that are created when a road changes from single- to multiply-digitized road.

As a further example, the management system 10 may be integrated with a Forward Collision Warning (FCW) and ACC systems to provide locations of road attributes, such as, signs and overpasses along the traveled path. Such signs and overpasses may be a source of false activation in the FCW or ACC system. Accordingly, the map database of the FCW or ACC and the activation classification component 14 cooperate to extract road attributes and locations relative to the vehicle for possible suppression/modification of the activation outputs 18. It is understood that the management system and methods for managing false activations used for the CSW system may also applied to a map based/navigation based Predictive Adaptive Front Lighting system.

The false alarm management system 10 is adapted in be integrated with any vehicle system. As such, the management system 10 and method for managing false activations in the vehicle system maximize the accuracy of the activation outputs 18 generated and transmitted by the vehicle system. With more accurate activation outputs 18, the driver's confidence in the vehicle system and the associated activation outputs 18 is maximized.

From the foregoing description, one ordinarily skilled in the art can easily ascertain the essential characteristics of this invention and, without departing from the spirit and scope thereof, make various changes and modifications to the invention to adapt it to various usages and conditions

What is claimed is:

1. A management system comprising:
a vehicle system that generates and transmits an output; and
an activation classification component in communication with the vehicle system, wherein the activation classification component receives the output of the vehicle system, analyzes the output of the vehicle system, and controls the vehicle system in response to the output analysis.

2. The management system according to claim 1, wherein the vehicle system includes at least one of a Global Positioning System and a map database for determining a location where each of the outputs of the vehicle system is generated.

3. The management system according to claim 1, wherein the vehicle system is one of a Driver Awareness System, a Curve Speed Warning System, Predictive Adaptive Front Light System, an Adaptive Cruise Control System, a Stop Sign Warning system, a Forward Collision Warning System, a Lane Departure Warning System, a Lane Position Awareness System, a Most Likely Path system, and an Advanced Driver Assistance System.

4. The management system according to claim 1, wherein the output analysis includes determining if the output is associated with at least one of an error in a map database, an overpass scenario, a road merging scenario, a special intersection scenario, a change in the number of lanes, an error causing fixture, an error causing road attribute, and a multi-digitized road.

5. The management system according to claim 4, wherein the control of the vehicle system includes suppressing and modifying the output of the vehicle system.

6. The management system according to claim 1, further comprising a database in communication with the activation classification component, the database adapted to store a plurality of records, wherein each of the records includes a plurality of fields for representing a road fragment associated with the output of the vehicle system.

7. The management system according to claim 6, wherein the activation classification component is adapted to manage the records, the management of the records in the database including at least one of creating the records to be stored in the database, incrementing at least one of the fields of at least one of the records in response to the output received from the vehicle system, and decrementing at least one of the fields of at least one of the records in response to the output received from the vehicle system.

8. The management system according to claim 7, wherein the control of the vehicle system includes suppressing and modifying the output of the vehicle system at locations associated with at least one of the records having at least one of the fields incremented to exceed a pre-determined threshold value.

9. A management system comprising:
a vehicle system that generates and transmits an output;
a database adapted to store a plurality of records, wherein each of the records represents a road fragment associated with the output of the vehicle system; and
an activation classification component in communication with the database and the vehicle system, wherein the activation classification component receives the output of the vehicle system, analyzes the output of the vehicle system, manages the records in the database in response to the analysis of the output, and controls the vehicle system in response to at least one of the output analysis and the records in the database.

10. The management system according to claim 9, wherein the vehicle system includes at least one of a Global Positioning System and a map database for determining a location where each of the outputs of the vehicle system is generated.

11. The management system according to claim 9, wherein the vehicle system is one of a Driver Awareness System, a Curve Speed Warning System, Predictive Adaptive Front Light System, an Adaptive Cruise Control System, a Stop Sign Warning system, a Forward Collision Warning System, a Lane Departure Warning System, a Lane Position Awareness System, a Most Likely Path system, and an Advanced Driver Assistance System.

12. The management system according to claim 9, wherein each of the records includes a plurality of fields representing at least one of a Segment ID, a Distance from Left Node (DLN), a road fragment Length, a Direction, a Number of Suppressed Activations, and a Number of False Activations.

13. The management system according to claim 12, wherein the management of the records in the database includes at least one of creating the records to be stored in the database, incrementing at least one of the fields of at least one of the records in response to the output received from the vehicle system, and decrementing at least one of the fields of at least one of the records in response to the output received from the vehicle system.

14. The management system according to claim 13, wherein the control of the vehicle system includes suppressing and modifying the output of the vehicle system at locations associated with at least one of the records having at least one of the fields incremented to exceed a pre-determined threshold value.

15. The management system according to claim 9, wherein the output analysis includes determining whether the output is a false or a valid output.

16. The management system according to claim 9, wherein the output analysis includes determining if the output is associated with at least one of an error in a map database, an overpass scenario, a road merging scenario, a special intersection scenario, a change in the number of lanes, an error causing fixture, an error causing road attribute, and a multi-digitized road.

17. A method for managing false activation outputs in a vehicle system, the method comprising the steps of:
analyzing an output of the vehicle system;
storing a plurality of records, wherein each record represents a road fragment associated with the output of the vehicle system;
managing the records in response to the analysis of the output of the vehicle system; and
controlling the output of the vehicle system in response to at least one of the output analysis and the stored records.

18. The method according to claim 17, wherein each of the records includes a plurality of fields representing at least one of a Segment ID, a Distance from Left Node (DLN), a road fragment Length, a Direction, a Number of Suppressed Activations, and a Number of False Activations.

19. The method according to claim 18, wherein the management of the records includes at least one of creating the records to be stored on a database, incrementing at least one of the fields of at least one of the records in response to the output received from the vehicle system, and decrementing at least one of the fields of at least one of the records in response to the output received from the vehicle system.

20. The method according to claim 19, wherein the control of the output of the vehicle system includes suppressing and modifying the output of the vehicle system at locations associated with at least one of the records having at least one of the fields incremented to exceed a pre-determined threshold value.
